(19) United States
(12) Patent Application Publication
(10) Pub. No.: US 2001/0031323 A1
(43) Pub. Date: Oct. 18, 2001

(54) Method of coating a pole and the pole made thereby

(76) Inventor: Young Gu Song, Incheon (KR)

Correspondence Address: STAAS & HALSEY LLP, 700 11TH STREET, NW, SUITE 500, WASHINGTON, DC, 20001, US

(21) Appl. No.: 09/749,427

(22) Filed: Dec. 28, 2000

(30) Foreign Application Priority Data
Apr. 17, 2000 (KR) 2000-0019924

(51) Int. Cl. B32B 1/08; B29C 67/00; B29C 47/02; B29D 22/00

(52) U.S. Cl. 428/34.5; 264/132; 264/136; 264/171.12; 428/34.7; 428/36.91

(57) ABSTRACT

There are provided a pole coating method and a pole fabricated by the same. The pole coating method injects at least one plastics selected from polyester, nylon, PVC(polyvinyl chloride), polyethylene, polypropylene, CAB(cellulose acetate butyrate) or ABS(acrylonitrile butadiene sthylene) to coat an FRP(Fiber Reinforced Plastics) pipe that is made in a manner that a glass fiber or carbon fiber (referred to as “glass fiber” hereinafter) is dipped in an unsaturated polyester resin to be drawing-molded. The pole is fabricated by the method of injecting at least one plastics selected from polyester, nylon, PVC(polyvinyl chloride), polyethylene, polypropylene, CAB(cellulose acetate butyrate) or ABS(acrylonitrile butadiene sthylene) to coat an FRP(Fiber Reinforced Plastics) pipe that is made in a manner that a glass fiber is dipped in an unsaturated polyester resin to be drawing-molded.

### BACKGROUND OF THE INVENTION

1. Field of the Invention

The present invention relates to a pole coating method and a pole fabricated by the same. Specifically, the present invention relates to a pole coating method which injects at least one plastics selected from polyester, nylon, PVC(polyvinyl chloride), polyethylene, polypropylene, CAB(cellulose acetate butyrate) or ABS(acrylonitrile butadiene sthylene) to coat an FRP(Fiber Reinforced Plastics) pipe that is made in a manner that a glass fiber or carbon fiber (referred to as “glass fiber” hereinafter) is dipped in an unsaturated polyester resin to be drawing-molded.

The present invention also relates to a pole fabricated by the method of injecting at least one plastics selected from polyester, nylon, PVC(polyvinyl chloride), polyethylene, polypropylene, CAB(cellulose acetate butyrate) or ABS(acrylonitrile butadiene sthylene) to coat an FRP(Fiber Reinforced Plastics) pipe that is made in a manner that a glass fiber is dipped in an unsaturated polyester resin to be drawing-molded.

The pole fabricated according to the present invention is generally used for maintaining a shape of a tent and also widely used as a support for keeping a shape of a vinyl plastic hothouse.

2. Description of the Related Art

In a prior art, a pole made of an FRP or a pole coated with paints was used for maintaining a shape of a tent and for keeping a shape of a vinyl plastic hothouse. However, this has the following problems. Firstly, in case where the pole made of the FRP is broken, the glass fiber forming the pole may be exposed to be damaged. Secondly, damages at the rough surface or connection part of the pole may bring about infiltration of the harmful glass fiber into the human body. Thirdly, the conventional pole has a low degree of hardness so that it is easily damaged. Fourthly, the pole is easily broken due to its weak strength and it cannot be reused. Fifthly, thick FRP is required for maintaining an appropriate strength of the pole, to increase in material costs and to raise manufacturing cost, resulting in decrease in price competitiveness. Sixthly, when the pole made of the lusterless FRP is coated with paints to obtain fine appearance, the paint easily peels off due to its weak adhesive strength to the pole and a long period of time is required for drying the paint after its coating on the pole.

To solve these problems, a pole is used which is fabricated in such a manner that an adhesive is coated on an FRP pipe or a plastic tube into which the FRP pipe can be inserted and then the FRP pipe is inserted into the plastic tube. This is shown in FIG. 5. FIG. 5 is a cross-sectional view showing the conventional pole that consists of an FRP pipe 7, an adhesive layer 11 and a plastic tube 12. As shown in FIG. 5, the conventional pole is fabricated in such a manner that the adhesive is coated on cylindrical FRP pipe 7 or plastic tube 12, the cylindrical FRP pipe 7 is inserted into plastic tube 12, and then they thermally adhere to each other at both ends. However, this conventional fabrication process is complicated to result in an increase in the manufacturing cost. In addition, the FRP pipe and the plastic tube may do not completely adhere to each other to be separated from each other to allow the FRP pipe to come out. Further, the plastic tube is torn so that it cannot function as a cover when the FRP pipe is broken.

### SUMMARY OF THE INVENTION

It is, therefore, an object of the present invention to provide a pole coating method which injects plastics to coat the surface of an FRP pipe and prints necessary information on the surface of the coated FRP pipe and the pole fabricated by the method.

To accomplish the object of the present invention, there is provided a pole coating method, comprising the steps of: maintaining an FRP pipe at a predetermined temperature; inserting the FRP pipe into an injection-coating molding apparatus; and uniformly injecting plastics to adhere to the surface of the FRP pipe in a predetermined thickness.

The above pole coating method may further comprises the steps of: inserting the FRP pipe to which the plastics adheres into a printing apparatus; and printing predetermined contents on the surface of the FRP pipe.

The FRP pipe is formed through the steps of: providing plural pieces of glass fibers into a tank filled with a melted unsaturated polyester resin; dipping the plural pieces of glass fibers in the melted unsaturated polyester resin; and inserting the plural pieces of glass fiber drenched with the unsaturated polyester resin into a drawing-molding apparatus while maintaining a predetermined temperature, to draw the FRP pipe.

The plastics is preferably configured of at least one selected from plastics selected from polyester, nylon, PVC(polyvinyl chloride), polyethylene, polypropylene, CAB(cellulose acetate butyrate) or ABS(acrylonitrile butadiene sthylene).

It is preferable that the thickness of the plastics coated on the FRP pipe is 0.3 to 3 mm, and the predetermined temperature is 200 to 250° C.

To accomplish the object of the present invention, there is provided a pole fabricated by the above-described pole coating method.

### DETAILED DESCRIPTION OF THE PREFERRED EMBODIMENT

Reference will now be made in detail to the preferred embodiments of the present invention, examples of which are illustrated in the accompanying drawings.

FIG. 1 shows an embodiment of a pole fabricating process according to the present invention. FIG. 2 is an enlarged cross-sectional view of an FRP pipe 100 that is drawing-molded according to the present invention. Referring to FIG. 2, FRP pipe 100 has a space 8 at its center and a body 7 surrounding space 8. FIG. 3 is an enlarged cross-sectional view of an FRP pipe 200 that is injection-coated with plastics. Referring to FIG. 3, a plastic layer 10 is coated on the surface of body 7.

The pole fabricating process of the present invention is explained in detail with reference to FIG. 1. The present invention uses an unsaturated polyester resin and glass fiber or carbon fiber in order to make the FRP pipe using the conventional FRP fabricating method. Further, at least one plastics selected from polyester, nylon, PVC(polyvinyl chloride), polyethylene, polypropylene, CAB(cellulose acetate butyrate) or ABS(acrylonitrile butadiene sthylene) can be used as plastics 10 covering the FRP pipe.

In a dipping step, it is preferable to use glass fiber 1 whose weight corresponds to 50 to 80% of the gross weight when it is drenched with a melted unsaturated polyester resin 2. In an FRP pipe drawing-molding step, it is preferable to maintain the drawing-molding ambient at which glass fiber 1 drenched with the unsaturated polyester resin is formed into the cylindrical FRP pipe at 200 to 250° C.

In a plastics injection-coating step, it is preferable that the drawing-molding step ambient at 200 to 250° C. is continuously maintained in order to easily melt plastics 10 to adhere to the surface of the cylindrical FRP pipe. In addition, it is preferable that the thickness of plastics 10 melted to adhere to the cylindrical FRP pipe is 0.3 to 3 mm.

The pole coating process according to the present invention is explained hereinafter. To give an appropriate strength to the cylindrical FRP pipe, several pieces of glass fibers 1 are provided into a tank 2′ filled with the melted unsaturated polyester resin. Here, several pieces of glass fibers 1 whose weight corresponds to 50 to 80% of the gross weight when they are drenched with the unsaturated polyester resin are dipped in the melted unsaturated polyester resin filled in tank 2′. Glass fibers 1 drenched with the unsaturated polyester resin are formed into the cylindrical FRP pipe through a drawing-molding apparatus 3 while the ambient of 200 to 250° C. is maintained. Here, both of the process of providing glass fibers 1 into tank 2′ and the process of dipping them in the polyester resin can be performed in the drawing-molding step.

Cylindrical FRP pipe 100 formed as above is inserted into an injection-coating molding apparatus 4 while maintaining the ambient at 200 to 250° C., and plastics 10 provided through a plastic pouring inlet 5 is uniformly injected to coat the surface of the FRP pipe. Finally, FRP pipe 200 to which the plastics adhere is cooled to obtain the FRP pipe covered with the plastic, i.e., pole. Subsequently, information on the FRP pipe such as its manufacturer or distributer can be printed on FRP pipe 200.

FIG. 4 shows another embodiment of the pole fabricating process according to the present invention. Since like components are indicated by like reference numerals in FIGS. 1 and 4, explanation on them is omitted. FRP pipe 200 coated with the plastics is inserted into a printing machine 6 to print necessary information on the surface of FRP pipe 200. A FRP pipe 300 on which the information is printed is cut into a predetermined size, accomplishing a pole. The printed contents may include the kind of a product, lot numbers, items, manufacturing dates and manufacturer. These contents can provide important information required for clearing up the cause of poor poles. Printing machine 6 may be a printer, preferably, an inkjet printer because it can perform printing on almost all material and has excellent ink adhesiveness.

It will be understood that various omissions and substitutions and changes in the form and details of the disclosed invention may be made by those skilled in the art without departing from the spirit of the invention.

The pole coating method and the pole made by the same according to the present invention described above have the following advantages. Firstly, the processes of coating the plastics on the FRP pipe are continuously carried out to simplify the fabrication process and to decrease the manufacturing cost. Secondly, since the plastics is injected to be coated on the FRP pipe, the plastics can closely adhere to the surface of the FRP pipe. This prevents the plastics from being separated from the FRP pipe. Thirdly, the thickness of the plastics coated on the FRP pipe can be adjusted by controlling the injection-coating molding apparatus. Fourthly, since the plastics is melted to adhere to the FRP pipe, the FRP pipe is not exposed even if the pole is broken. Thus, the glass fiber harmful to the human body is prevented from damaging users. Fifthly, information on the pole is continuously printed on the surface of the FRP pipe coated with the plastics to allow the fabrication process to be simplified. Furthermore, the FRP pipe coated with the plastics is in a heated state and has less impurities due to successive processes so that the adhesion strength between the surface of the FRP pipe coated with the plastics and the printed ink layer is strong to prevent the ink layer from peeling off.

### BRIEF DESCRIPTION OF THE DRAWINGS

FIG. 1 shows an embodiment of a pole coating process according to the present invention;

FIG. 2 is a cross-sectional view of an FRP pipe fabricated according to the present invention;

FIG. 3 is a cross-sectional view of a pole injection-coated with plastics according to the present invention;

FIG. 4 is another embodiment of a pole coating process according to the present invention; and

FIG. 5 is a cross-sectional view of a conventional pole.

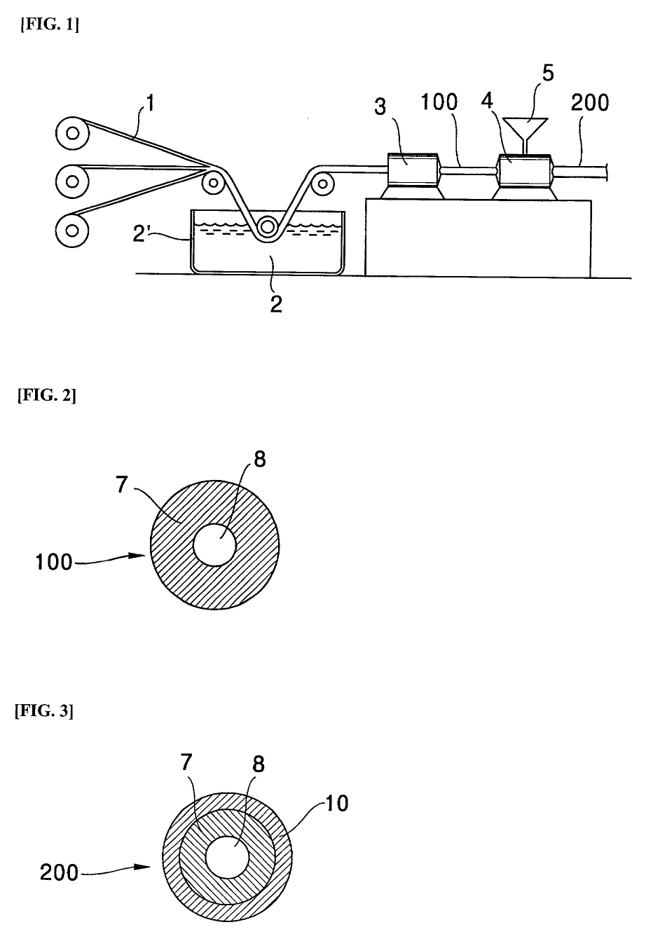

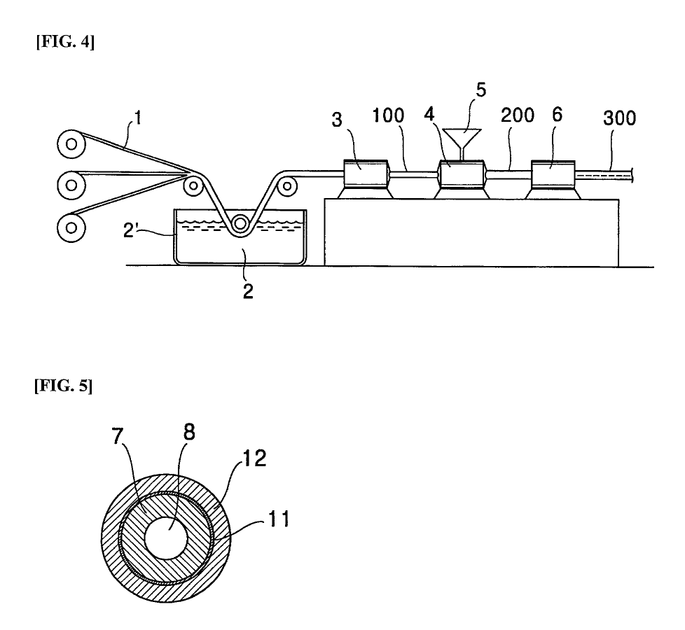

What is claimed is:

1. A pole coating method, comprising the steps of:
maintaining an FRP pipe at a predetermined temperature;
inserting the FRP pipe into an injection-coating molding apparatus; and
uniformly injecting plastics to adhere to the surface of the FRP pipe in a predetermined thickness.

2. The pole coating method as claimed in claim 1, further comprising the steps of:
inserting the FRP pipe to which the plastics adheres into a printing apparatus; and
printing predetermined contents on the surface of the FRP pipe.

3. The pole coating method as claimed in claim 1, the FRP pipe is formed through the steps of:
providing plural pieces of glass fibers into a tank filled with a melted unsaturated polyester resin;
dipping the plural pieces of glass fibers in the melted unsaturated polyester resin; and
inserting the plural pieces of glass fiber drenched with the unsaturated polyester resin into a drawing-molding apparatus while maintaining a predetermined temperature, to draw the FRP pipe.

4. The pole coating method as claimed in claim 1, wherein the plastics is configured of at least one selected from plastics selected from polyester, nylon, PVC(polyvinyl chloride), polyethylene, polypropylene, CAB(cellulose acetate butyrate) or ABS(acrylonitrile butadiene sthylene).

5. The pole coating method as claimed in claim 1, wherein the thickness of the plastics coated on the FRP pipe is 0.3 to 3 mm.

6. The pole coating method as claimed in claim 1, wherein the predetermined temperature is 200 to 250° C.

7. A pole fabricated by one of the pole coating methods of claims 1 to 6.
